(19) United States
(12) Patent Application Publication
(10) Pub. No.: US 2013/0311306 A1
(43) Pub. Date: Nov. 21, 2013

(54) PROVIDING FOCUS TO A SEARCH MODULE PRESENTED ON A DYNAMIC WEB PAGE

(71) Applicants: Li-Jen (Girvan) Liu, Taipei (TW); Ting-Liang (Liang) Chou, Taipei (TW); Geng-Dian (GD) Huang, Taipei (TW)

(72) Inventors: Li-Jen (Girvan) Liu, Taipei (TW); Ting-Liang (Liang) Chou, Taipei (TW); Geng-Dian (GD) Huang, Taipei (TW)

(73) Assignee: YAHOO! INC., Sunnyvale, CA (US)

(21) Appl. No.: 13/476,442

(22) Filed: May 21, 2012

(51) Int. Cl. G06Q 30/02; G06F 17/30

(52) U.S. Cl. 705/14.73; 707/709; 707/E17.108

(57) ABSTRACT

Techniques are described herein for providing focus to a search module presented on a dynamic web page. The search module is configured to include an interface element for performance of a web search. Focus is provided to the search module by removing other modules from the presentation of the dynamic web page upon detecting an input from a user that activates the search module. In one example, component(s) of the search module (e.g., the interface element) may also be re-located and/or re-sized to further facilitate in providing focus to the search module. In another example, other modules associated with the search module may be added to the presentation of the dynamic web page in response to detecting the input from the user that activates the search module.

### BACKGROUND OF THE INVENTION

1. Field of the Invention

The present invention relates to changing a presentation of a search module presented on an online web page for facilitating a web search.

2. Background

Publishers of web content (and particularly aggregators of web content such as Yahoo! Inc., Google Corporation, Microsoft Corporation, AOL Inc., etc.) often have a vested interest in delivering content that is of interest to their users. For example, the more time a user spends on a publisher's web site, potentially increasing an amount of money the publisher may make due to increased ad revenue. Thus, publishers are often driven to provide relevant content to users in hopes that the users will spend more time on their web sites.

One technique publishers have used to attract more users is to provide content via a web portal. A web portal may comprise a web site or web page that offers a broad array of information and/or services, such as e-mail, forums, search engines, news, weather information, stock quotes, etc.

However, providing such a broad array of information and/or services may cause the web portal to become cluttered. As such, the ability to add additional information and/or services to the web portal may become problematic. For example, as search engine technology has developed, search engines have been adapted to provide additional features that assist a user in locating desired information. These additional features require space that is often consumed by the other information and/or services provided by publishers.

### BRIEF SUMMARY OF THE INVENTION

Various approaches are described herein for, among other things, directing a user's attention (i.e., focus) to a search module presented on a web page. The search module is configured to include an interface element for performance of a web search. Focus is provided to the search module by removing other modules from a presentation of the web page upon detecting an input from the user that activates (i.e., initiates use of) the search module. In one example, component(s) of the search module (e.g., the interface element) also may be re-located and/or re-sized to further facilitate in providing focus to the search module. In another example, other modules associated with the search module may be added to the presentation of the web page in response to detecting the input from the user that activates the search module.

An example method is described in which a dynamic web page is provided. The dynamic web page includes modules for presentation to a user. The modules include a search module configured to include an interface element for performance of a web search and additional module(s) via which respective instance(s) of dynamic media content are to be presented. Each instance of the dynamic media content includes textual content, graphical content, video content, and/or audio content. Input from a user is detected that initiates use of the search module. The additional module(s) are removed from the presentation of the dynamic web page such that the presentation of the dynamic web page includes the search module without the additional module(s) in response to detecting the input from the user.

A system is described that includes presentation logic, detection logic, and removal logic. The detection logic is configured to provide a dynamic web page that includes modules for presentation to a user. The modules include a search module configured to include an interface element for performance of a web search and additional module(s) via which respective instance(s) of dynamic media content are to be presented. Each instance of the dynamic media content includes textual content, graphical content, video content, and/or audio content. The detection logic is configured to detect an input from the user that initiates use of the search module. The removal logic is configured to remove the additional module(s) from the presentation of the dynamic web page such that the presentation of the dynamic web page includes the search module without the additional module(s) in response to detection of the input from the user.

An example computer program product is described that includes a computer-readable medium having computer program logic recorded thereon for enabling a processor-based system to provide focus to a search module. The computer program product includes a first program logic module, a second program logic module, and a third program logic module. The first program logic module is for enabling the processor-based system to provide a dynamic web page that includes modules for presentation to a user. The modules include a search module configured to include an interface element for performance of a web search and additional module(s) via which respective instance(s) of dynamic media content are to be presented. Each instance of the dynamic media content includes textual content, graphical content, video content, and/or audio content. The second program logic module is for enabling the processor-based system to activate the search module based on receipt of an activation instruction from the user. The activation instruction indicates that the search module is to be activated. The third program logic module is for enabling the processor-based system to remove the additional module(s) from the presentation of the dynamic web page such that the presentation of the dynamic web page includes the search module without the additional module(s) in response to receipt of the activation instruction from the user.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example system in accordance with an embodiment described herein.

FIG. 2 depicts a flowchart of an example method for providing focus to a search module presented on a dynamic web page in accordance with an embodiment described herein.

FIG. 3 depicts a flowchart of an example method for adding other modules to a dynamic web page in response to detecting text entered into an interface element included in a search module in accordance with an embodiment described herein.

FIG. 4 is a block diagram of an example implementation of a focus-enabled web page module shown in FIG. 1 in accordance with an embodiment described herein.

FIG. 5 shows a dynamic web page in which a search module and additional module(s) are presented in accordance with an embodiment described herein.

FIG. 6 shows a presentation of a dynamic web page in which focus is provided to a search module in accordance with an embodiment described herein.

FIG. 7 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention. include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Example embodiments are capable of directing a user's attention (i.e., focus) to a search module presented on a web page. The search module is configured to include an interface element for performance of a web search. Focus is provided to the search module by removing other modules from the presentation of the web page upon detecting an input from a user that activates (i.e., initiates use of) the search module. In one example, component(s) of the search module (e.g., the interface element) may also be re-located and/or re-sized to further facilitate in providing focus to the search module. In another example, other modules associated with the search module may be added to the presentation of the web page in response to detecting the input from the user that activates the search module.

### II. Example Embodiments

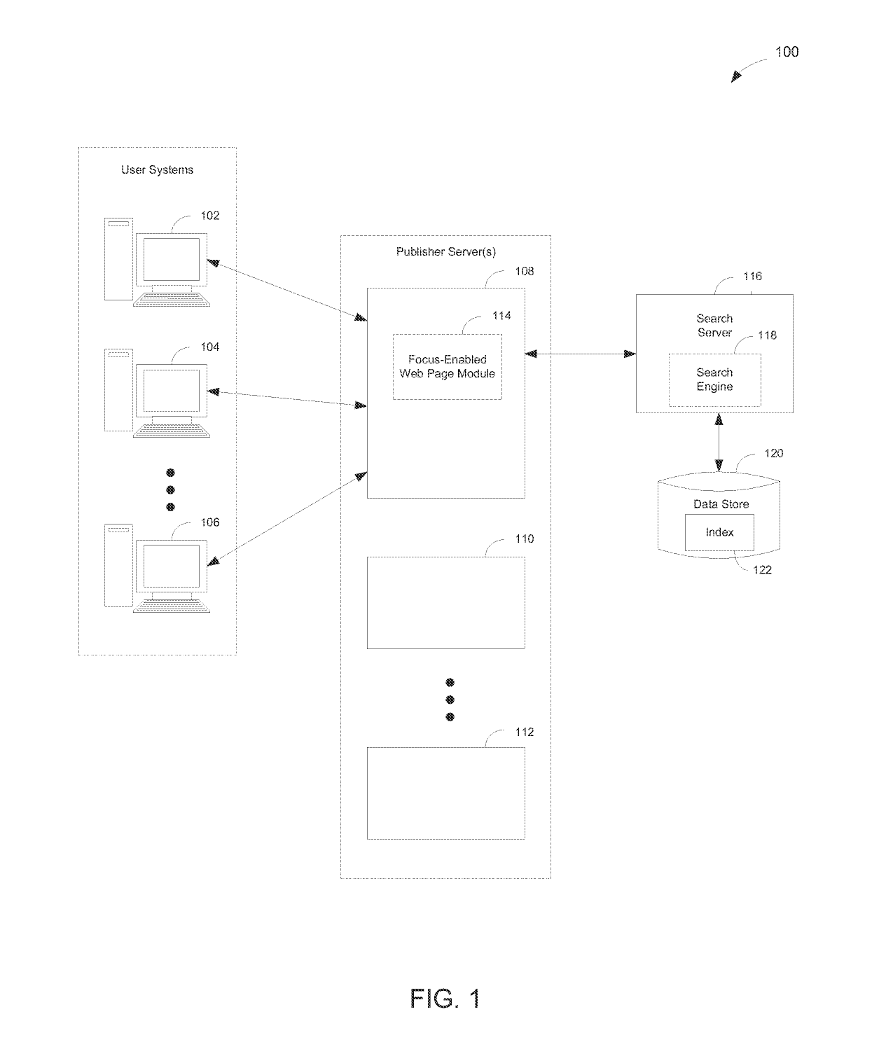

FIG. 1 is a block diagram of an example system 100 in accordance with an embodiment described herein. Generally speaking, system 100 operates to direct a user's attention (i.e., focus) to a search module presented on a web page. The search module is configured to include a search interface element for performance of a web search. Focus is provided to the search module by removing other modules from the presentation of the web page upon detecting an input from the user that activates (i.e., initiates use of) the search module. In some example embodiments, component(s) of the search module (e.g., the search interface element) may also be re-located and/or re-sized to further facilitate in providing focus to the search module. In other example embodiments, other modules associated with the search module may be added to the presentation of the web page in response to detecting an input from the user that activates the search module.

In accordance with an embodiment, the web page is provided as a dynamic web page. A dynamic web page is a web page that includes content that is capable of changing without generating new “page views” (e.g., a portion of the content of the web page may change without reloading the web page). Dynamic web pages may be generated in various ways. For instance, dynamic web pages may be generated using client-side scripting languages (e.g., JavaScript®). The content of a dynamic web page may change due to a user interacting with feature(s) of the web page. For example, a user viewing a dynamic web page may move a cursor over (e.g., hover the cursor over), or click on, features presented on the dynamic web page. By moving the cursor over or clicking on features displayed on the dynamic web page, content displayed on the dynamic web page may be modified, such as by changing a location and/or a size of the feature, displaying or modifying an image associated with the feature, displaying or modifying text related to the feature, removing feature(s), adding additional feature(s), etc. In accordance with this embodiment, the modification of the modules mentioned above may occur without reloading the dynamic web page, thereby providing seamless interaction with the dynamic web page for the user.

As shown in FIG. 1, system 100 includes a plurality of user systems 102, 104, and 106, a plurality of publisher servers 108, 110, and 112, a search server 116, and a data store 120. Communication among user systems 102, 104, and 106, publisher servers 108, 110, and 112, search server 116, and data store 120 is carried out over a network using well-known network communication protocols. The network may include a wide-area network (e.g., the Internet), a local area network (LAN), another type of network, wire-line type connections, wireless type connections, or any combination thereof. For instance, the network may include sub-networks that are capable of interoperating. In accordance with this example, such sub-networks may employ differing architectures and/or may be compliant and/or compatible with differing protocols. Various types of devices may be made available to provide an interoperable capability for differing architectures or protocols. As one illustrative example, a router may provide a link between otherwise separate and independent LANs.

User systems 102, 104, and 106 are computers or other processing systems, each including one or more processors, that are capable of communicating with any one or more of publisher servers 108, 110, and 112. For example, each of user systems 102, 104, and 106 may include a client that enables a user who owns (or otherwise has access to) the user system to access sites (e.g., web sites) that are hosted by publisher servers 108, 110, and 112. For instance, a client may be a web crawler, a web browser, a non-web-enabled client, or any other suitable type of client.

By way of example, each of user systems 102, 104, and 106 is shown in FIG. 1 to be communicatively coupled to publisher server 108 for the purpose of accessing a site published by publisher server 108. Persons skilled in the relevant art(s) will recognize that each of user systems 102, 104, and 106 is capable of connecting to any of publisher servers 108, 110, and 112 for accessing the sites hosted thereon. In addition, although three user systems 102, 104, and 106 and three publisher servers 108, 110, and 112 are depicted in FIG. 1, persons skilled in the relevant art(s) will recognize that any number of user systems may be communicatively coupled among any number of publisher servers.

Although user systems 102, 104, and 106 are depicted as desktop computers in FIG. 1, persons skilled in the relevant art(s) will appreciate that user systems 102, 104, and 106 may include any browser-enabled system or device, including but not limited to a handheld computer, a laptop computer, a tablet computer, a set top box, a wearable computer, a personal digital assistant, a cellular telephone, a display pager, a radio frequency (RF) device, an infrared (IR) device, or the like.

Publisher servers 108, 110, and 112 are computers or other processing systems, each including one or more processors, that are capable of communicating with user systems 102, 104, and 106. Examples of a publisher server include but are not limited to a dedicated rack-mounted server, a desktop computer, a laptop computer, a set top box, etc. Each of publisher servers 108, 110, and 112 is configured to host a site (e.g., a web site) published by a corresponding publisher so that such site is accessible to users of system 100 via user systems 102, 104, and 106. Each of publisher servers 108, 110, and 112 is further configured to provide a web page that includes a plurality of modules for presentation to a user. The plurality of modules provided by at least one of the publisher servers 108, 110, and 112 includes a search module configured to include a search interface element for performance of a web search and other module(s) to users of system 100 when those users access a web site that is hosted by the respective publisher server.

In an example embodiment, at least one of the publisher servers 108, 110, and 112 is configured to host a web site, published by a search engine provider, that includes the search module. The search module is configured to include a search interface element for performance of a web search using a search engine provided by the search engine provider. In another example embodiment, at least one of the publisher servers 108, 110, and 112 is configured to host a web site, published by a third-party, that includes an embedded search module. The embedded search module is configured to perform a web search using a search engine provided by a particular search engine provider specified by the embedded search module.

Publisher servers 108, 110, and 112 are further configured to execute software programs that provide information to users in response to receiving requests, such as hypertext transfer protocol (HTTP) requests, from users, instant messaging (IM) applications, or web-based email. For example, the information may include web pages, images, other types of files, output of executables residing on the publisher servers, IM chat sessions, emails, coupons, gift certificates, advertisements, etc. In accordance with this example, the software programs that are executing on publisher servers 108, 110, and 112 may provide web pages and/or emails that include interface elements (e.g., buttons, widgets, hyperlinks, etc.) that a user may select for accessing the other types of information. The web pages may be provided as hypertext markup language (HTML) documents and objects (e.g., files) that are linked therein, for example. In accordance with an embodiment, the web pages are provided as a dynamic web page, which may be generated in various ways, including being generated with client-side scripting languages (e.g., JavaScript®).

Publisher server 108 is shown to include focus-enabled web page module 114. Focus-enabled web page module 114 is configured to provide focus to the search module upon detecting input from a user that initiates use of the search module. For example, the search module may include one or components that, when activated, cause the focus-enabled web page module 114 to provide focus to the search module. The component(s) include, but are not limited to, a search interface element (e.g., a text box), in which a user may enter text that forms a search query, and a search button that may be selected by the user to cause the search query to be submitted to a search engine.

In an example embodiment in which the search module is presented via a dynamic web page, activation of the search module may occur upon detecting text being entered into the search interface element that is included in the search module. In accordance with this embodiment, one or more search queries are submitted to a search engine in real-time as the text is being entered into the search interface element. In addition, component(s) of the search module may be re-located and/or re-sized, additional modules and/or advertisements that are presented via the web page may be removed, other modules and/or advertisements may be added to the presentation of the web page, etc. upon detecting the text being entered into the search interface element. In accordance with this embodiment, the modification of the modules may occur without reloading the dynamic web page, thereby providing seamless interaction with the dynamic web page for the user. In another example embodiment in which the search module is presented via a dynamic web page, activation of the search module occurs based on the search interface element included in the search module being selected by the user.

In an example embodiment in which the search module is presented via a non-dynamic web page, activation of the search module may occur based on the search button being selected (e.g., clicked on). In accordance with this embodiment, one or more search queries are submitted to a search engine upon activation of the search button. In addition, component(s) of the search module may be re-located and/or re-sized, additional modules and/or advertisements that are presented via the web page may be removed, other modules and/or advertisements may be added to the presentation of the web page, etc. upon activation of the search button.

In another example embodiment, the additional modules that are removed upon activation of the search module include respective instances of dynamic media content that are presented via the web site. Dynamic media content may include time-sensitive content, including but not limited to news, current events, trending topics, and/or the like. Each instance of the dynamic media content includes textual content, graphical content, video content, audio content, or any combination thereof.

Space in the presentation of the web page previously occupied by additional modules and/or advertisements that are removed from the presentation of the web page can be used to display other modules and/or advertisements in response to detecting input from the user that initiates use of the search module. For example, suggestion module(s) may be added to the presentation of the web page. In accordance with this example, a suggestion module may include one or more suggested search queries that are based on a search query entered into the search interface element that is included in the search module. Accordingly, in an example embodiment in which the search module is presented via a dynamic web page, the suggestion module is added to the presentation upon detecting that text is entered into the search interface element included in the search module. In addition, the one or more suggested search queries presented in the suggestion module may be updated in real-time as a user types a search query into the search interface element. In another example embodiment in which the search module is presented via a dynamic web page, the suggestion module includes one or more suggested search queries that are based on searches that are performed by other users and/or trending topics. In accordance with this embodiment, the suggestion module is added to the presentation of the dynamic web page in response to the search interface element in the search module being selected by the user or in response to detecting that text is entered into the search interface element.

In another example embodiment, result module(s) are added to the presentation of the web page in response to detecting input from a user that initiates use of the search module. For example, a result module may include search result(s) that are based on a search query formed by text entered into the search interface element included in the search module. In an example embodiment in which the search module is presented via a dynamic web page, result module(s) may be added to the presentation of the dynamic web page in response to detecting text entered into the search interface element included in the search module. In addition, the search results presented in the result module may be updated in real-time as a user types a search query into the search interface element. In another example embodiment in which the search module is presented via a dynamic web page, the result module includes search result(s) that are based on searches that are performed by other users and/or trending topics. In accordance with this embodiment, the result module is added to the presentation of the dynamic web page in response to the search interface element in the search module being selected by the user or in response to detecting that text is entered into the search interface element.

In yet another example embodiment, filter module(s) are added to the presentation of the web page in response to detecting input from a user that initiates use of the search module. A filter module is a module that is configured to filter search results received based on a search query formed by text entered into the search interface element that is included in the search module. Filter module(s) are configured to filter search results in response to the filter module(s) being activated.

In still another example embodiment, a return module is added to the presentation of the web page in response to detecting input from a user that initiates use of the search module. The return module is configured to include a return interface element (e.g., a button) for returning the presentation of the web page to an original state. In accordance with this embodiment, the presentation of the web page is returned to the original state upon activation of the return interface element in the return module.

In yet another example embodiment, advertisements are added to the presentation of the web page in response to detecting input from a user that initiates use of the search module. The number of advertisements added to the presentation of the web page may be greater than, less than, or equal to the number of advertisements shown before detecting the input from the user that initiates use of the search module. In an example embodiment in which the search module is presented via a dynamic web page, advertisement(s) are added to the presentation of the dynamic web page upon detecting input from the user that initiates use of the search module.

In still another example embodiment, one or more modules selected from the additional modules and/or one or more advertisements selected from the advertisements that are initially presented via the web page are not removed from the web page in response to detecting the input from the user that initiates use of the search module. In accordance with this embodiment, the suggestion module, results module(s), filter module(s) modules, return module and/or advertisements that are provided in response to detecting the input from the user that initiates use of the search module are configured to overlay the one or more modules and/or the one or more advertisements. Each of the one or more modules and/or each of the one or more advertisements may be partially overlaid or fully overlaid. In one aspect of this embodiment, the suggestion module, results module(s), filter module(s) modules, return module and/or advertisements that are provided in response to detecting the input from the user that initiates use of the search module may be opaque, thereby making an overlaid portion of the one or more modules and/or the one or more advertisements no longer visible to the user. In another aspect of this embodiment, at least a portion of the suggestion module, results module(s), filter module(s) modules, return module and/or advertisements may be semi-transparent, thereby making an overlaid portion of the one or more modules and/or the one or more advertisements at least partially visible to the user.

It is noted that in the example embodiment described above, at least one of the one or more additional modules and/or at least one of the advertisements may be removed in response to detecting the input from the user that initiates use of the search module, while at least another one of the one or more additional modules and/or at least another one of the advertisements may be overlaid in response to detecting the input from the user that initiates use of the search module.

Search server 116 is a computer or other processing system, including one or more processors, that is capable of executing a search engine 118. Examples of a search server include but are not limited to a dedicated rack-mounted server, a desktop computer, a laptop computer, a set top box, etc. Search engine 118 is configured to query an index 122 located in data store 120 using search queries that are provided by users. As mentioned above, a user may provide a search query by entering text into the search interface element that is included in the search module. For example, when text is entered into the search interface element to generate the search query, search server 116 receives the search query from publisher server 108, which hosts the web page that presents the search module. Upon determining instance(s) of information stored in index 122 that are relevant to the user's search query, search server 116 provides the instance(s) of the information as respective search result(s) to publisher server 108. Focus-enabled web page module 114, which is included in publisher server 108, formats the search result(s) into result module(s) and adds the result module(s) to the presentation of the web site. While FIG. 1 depicts search engine 118 as being executed by search server 116, it will be recognized that search engine 118, or some or all functionality thereof, may be incorporated into focus-enabled web page module 114.

By way of example, search server 116 is shown in FIG. 1 to be communicatively coupled to publisher server 108 for illustrative purposes to provide search result(s) to publisher server 108 and is not intended to be limiting. Persons skilled in the relevant art(s) will recognize that search server 116 may be communicatively coupled to any one or more of publisher servers 108, 110, and 112 for providing search result(s) thereto. In addition, although one search server 116 is depicted in FIG. 1, persons skilled in the relevant art(s) will recognize that any number of search servers may be communicatively coupled among publisher servers 108, 110, and 112.

Data store 120 is configured to store the index 122, which indexes documents, such as documents found on the Internet. Data store 120 may be any suitable type of data store. One type of data store is a database. For instance, data store 120 may be a relational database, an entity-relationship database, an object database, an object relational database, an extensible markup language (XML) database, etc.

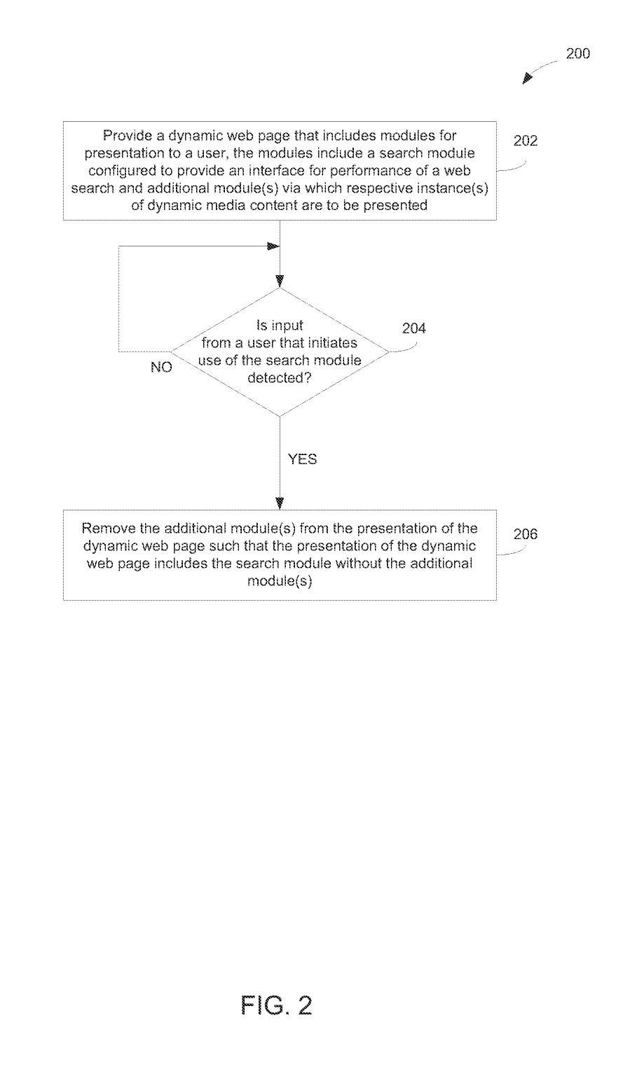

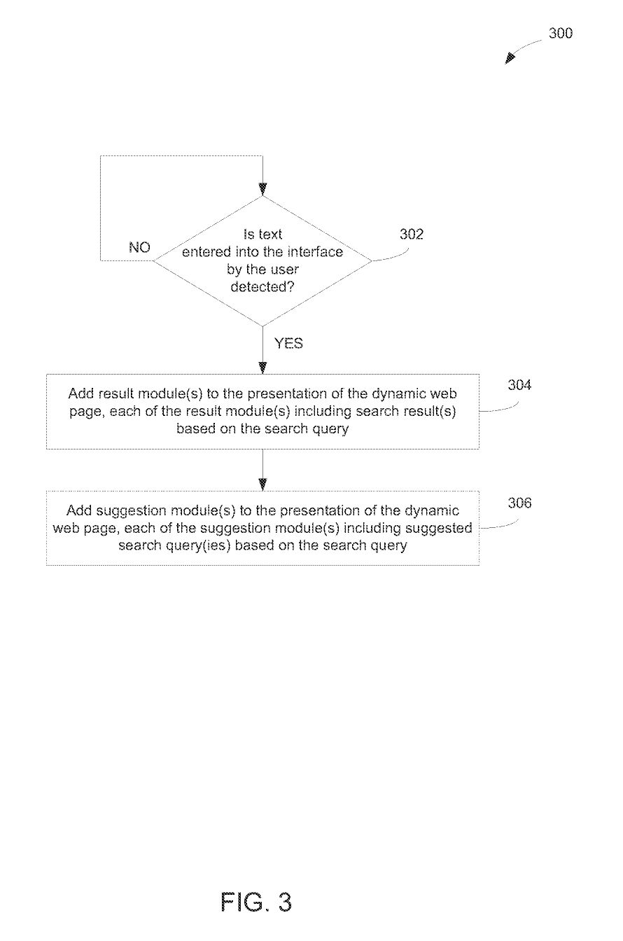

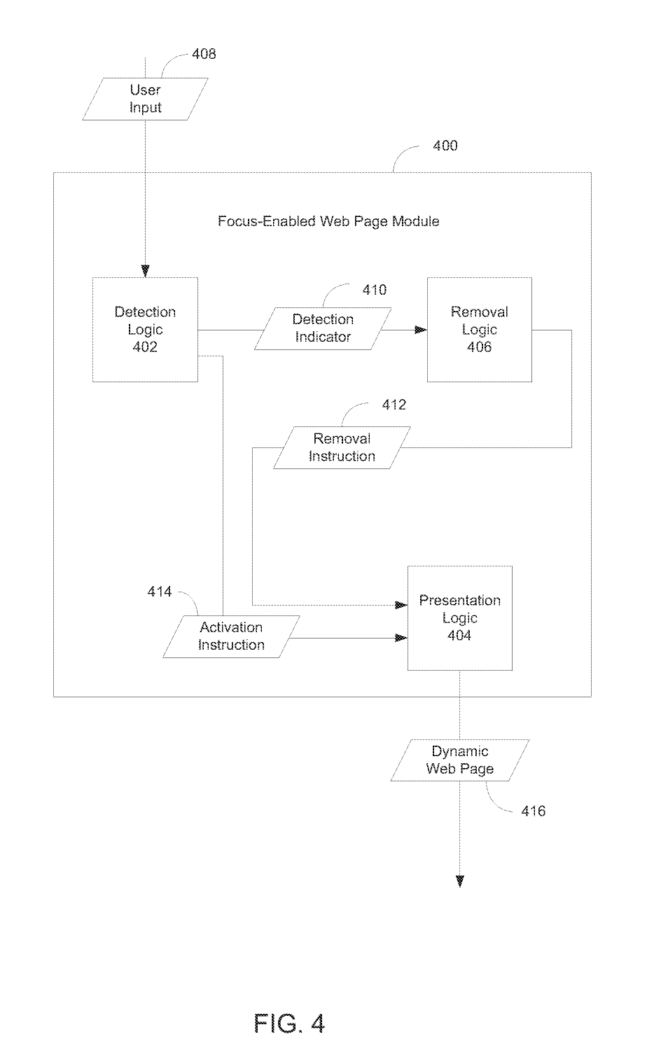

FIG. 2 depicts a flowchart 200 of an example method for providing focus to a search module presented on a dynamic web page in accordance with an embodiment described herein. FIG. 3 depicts a flowchart 300 of an example method for adding other modules to a dynamic web page in response to detecting text entered into a search interface element in accordance with an embodiment described herein. Flowcharts 200 and 300 may be performed by focus-enabled web page module 114, for example. For illustrative purposes, flowcharts 200 and 300 are described with respect to focus-enabled web page module 400 shown in FIG. 4, which is an example of focus-enabled web page module 114, according to an embodiment. As shown in FIG. 4, focus-enabled web page module 400 includes detection logic 402, presentation logic 404, and removal logic 406. Further structural and operational embodiments will be apparent to persons skilled in the relevant art(s) based on the discussion regarding flowcharts 200 and 300.

As shown in FIG. 2, the method of flowchart 200 begins at step 202. In step 202, a dynamic web page that includes modules for presentation to a user is provided. The modules include a search module configured to include a search interface element for performance of a web search. The modules also include additional module(s) via which respective instance(s) of dynamic media content are to be presented. Each instance of the dynamic media content includes textual content, graphical content, video content, and/or audio content. In an example embodiment, each instance of the dynamic media content includes one or more files. In an example implementation, presentation logic 404 provides dynamic web page 416.

Dynamic media content may include time-sensitive content, including but not limited to news, current events, trending topics, and/or the like. In accordance with an embodiment, each additional module corresponds to a respective category of subject matter (e.g., news, sports, finance, technology, science, health, politics, entertainment, etc.). Each additional module may include caption(s) (e.g., titles, headlines, abstracts, etc.) that correspond to respective link(s). Each link is linked to a respective file of the dynamic media content that is associated with the category that corresponds to a respective additional module. For example, a link in an additional module associated with “technology” may be linked to a file (e.g., an article, an image, a video, an audio clip, and/or other type of content) related to technology; whereas, a link in an additional module associated with “politics” may be linked to a file related to politics.

At step 204, a determination is made whether input from the user that initiates use of the search module is detected. If the input is detected, flow continues to step 206. Otherwise, flow returns to step 204.

In one example embodiment, detecting the input includes detecting a mouse click received by the search interface element in the search module from the user, detecting text entered into the search interface element by the user, detecting a cursor being moved over (e.g., hovered over) the search interface element for at least a predetermined time interval, detecting a voice command from the user that is directed to initiate the use of the search interface element, detecting a gesture of the user that is directed to initiate the use of the search interface element, etc. Examples of a gesture include but are not limited to a hand being waved or pointing (perhaps in a specified manner) in front of a camera, a head of the user being moved (perhaps in a specified manner) in front of the camera, the user gazing at a display on which the interface element is presented, a facial expression being made, an object being touched on the display, etc. For example, a user system (e.g., user system 102, 104, or 106) may include a gyroscope and/or an accelerometer to detect movement and/or lack thereof, an infrared detector to detect proximity of the infrared detector to another object, and/or a light meter to detect presence and/or absence of light for determining whether an object is being placed proximate to the search interface element in the presentation of the dynamic web page, etc. In accordance with this example, focus-enabled web page module 400 may receive notification of such input from the user system. Accordingly, focus-enabled web page module 400 may detect the input based on receipt of the notification.

In an example implementation, detection logic 402 determines whether user input 408 that initiates the use of the search module is detected. If detection logic 402 detects the user input 408, detection logic 402 provides a detection indicator 410 to removal logic 406 and an activation instruction 414 to presentation logic 404. The detection indicator 410 indicates that the user input 408 is detected. The activation instruction 414 specifies that the search module is to be activated.

At step 206, the additional module(s) are removed from the presentation of dynamic web page such that the presentation of the dynamic web page includes the search module without the additional module(s). In an example implementation, removal logic 406 provides a removal instruction 412 to presentation logic 404 in response to receiving the detection indicator 410 from detection logic 402. The removal instruction 412 indicates that the additional module(s) are to be removed from the presentation of dynamic web page 416. Presentation logic 404 updates the presentation of the dynamic web page 416 in response to the receipt of the activation instruction 414 and the removal instruction 412.

In an example embodiment, a location of one or more components of the search module in the presentation of the dynamic web page is changed in response to detecting the input from the user. The component(s) include, but are not limited to a search interface element (e.g., a text box) in which a user may enter text that forms a search query and a search button that causes the search query to be submitted to a search engine in response to the search button being activated (e.g., selected by the user). In an example implementation, presentation logic 404 changes the location of the component(s) of the search module in the presentation of dynamic web page 416 in response to receipt of the activation instruction 414.

In another example embodiment, one or more physical dimensions of component(s) of the search module are changed in the presentation of the dynamic web page in response to detecting the input from the user. For example, the height and/or the width of the search interface element and/or the search button included in the search module may be changed. In an example implementation, presentation logic 404 changes the physical dimension(s) of the search module component(s) in the presentation of dynamic web page 416 in response to the receipt of activation instruction 414.

In some example embodiments, one or more steps 202, 204, and/or 206 of flowchart 200 may not be performed. Moreover, steps in addition to or in lieu of steps 202, 204, and/or 206 may be performed.

For example, FIG. 3 depicts a flowchart 300 of an example method for adding other modules to the dynamic web page in response to detecting text entered into the search interface element that is included in the search module. As shown in FIG. 3, the method of flowchart 300 begins at step 302. In step 302, a determination is made whether text entered into the search interface element by the user is detected. If the text is detected, flow continues to step 304. Otherwise, flow returns to step 302.

In an example implementation, detection logic 402 determines whether the text entered into the search interface element by the user is detected. If detection logic 402 determines that the text is detected (e.g., if detection logic 402 detects the text), detection logic 402 provides the detection indicator 410 to removal logic 406 and the activation instruction 414 to presentation logic 404.

At step 304, result module(s) are added to the presentation of the dynamic web page. In one example embodiment, each of the result module(s) includes search result(s) based on the search query formed by the text entered into the search interface element. In another example embodiment, each of the result module(s) further includes search result(s) that are based on search(es) that are performed by other user(s) and/or trending topics. In an example implementation, presentation logic 404 adds the result modules(s) to the presentation of the dynamic web page 416 in response to the receipt of the activation instruction 414.

In an example embodiment, other module(s) in addition to result module(s) are added to the presentation of the dynamic web page in response to detecting the text entered into the search interface element. For example, at step 306, suggestion module(s) are added to the presentation of the dynamic web page. In one example embodiment, each of the suggestion module(s) includes one or more suggested search queries based on the search query formed by the text entered into the search interface element. In another example embodiment, each of the suggestion module(s) further includes one or more suggested search queries that are based on search(es) that are performed by other user(s) and/or trending topics. In an example implementation, presentation logic 404 adds the suggestion modules(s) to the presentation of the dynamic web page 416 in response to the receipt of the activation instruction 414.

In another example embodiment, filter module(s) are added to the presentation of the dynamic web page in response to detecting the text entered into the search interface element. A filter module is a module that is configured to filter search results that are received based on a search query formed by the text entered into the search interface element. Filter module(s) filter the search results based on respective categories of subject matter (e.g., images, video, news, shopping, sports, travel, etc.). Filter module(s) are configured to filter search results in response to the filter module(s) being activated. A filter module may be activated, for example, based on the filter module being selected with a mouse click, a cursor being hovered over the filter module for at least a predetermined time interval, a voice command that is directed to activate the filter module, a gesture being directed to activate the filter module, etc. In an example implementation, presentation logic 404 adds the filter modules(s) to the presentation of the dynamic web page 416 in response to the receipt of the activation instruction 414.

In yet another example embodiment, a return module is added to the presentation of the dynamic web page in response to detecting text entered into the search interface element. The return module is configured to include a return interface element (e.g., a button) for returning the presentation of the web page to an original state. The presentation of the dynamic web page in its original state includes at least the search module (e.g., in its original size and location) and the additional modules and/or advertisements that were removed from the presentation of the dynamic web page when the text entered into the search interface element was detected. The presentation of the web page is returned to the original state upon activation of the return interface element in the return module. The return interface element may be activated by detecting a mouse click received by the return interface element, detecting a cursor being hovered over the return interface element for at least a predetermined time interval, detecting a voice command being directed to activate the return interface element, detecting a hand gesture being directed to activate the return interface element, and/or the like. In an example implementation, presentation logic 404 adds the return modules(s) to the presentation of the dynamic web page 416 in response to the receipt of the activation instruction 414.

In still another example embodiment, advertisements are added to the presentation of the web page in response to detecting the text entered into the search interface element. The number of advertisements added to the presentation of the web page may be greater than, less than, or equal to the number of advertisements shown before detecting the text entered into the interface element by the user that initiates use of the search module. For example, upon detecting text entered into the search interface element, M advertisements may be removed from the presentation of the dynamic web page such that the presentation of the dynamic web page includes the search module without the M advertisements. Subsequently, N advertisements are added to the presentation of the dynamic web page. N and M are integers. In one aspect of this embodiment, N is greater than M. In another aspect, N is less than M. In yet another aspect, N and M are equal. In an example implementation, presentation logic 404 adds and/or removes advertisements from the presentation of the dynamic web page 416 in response to the receipt of the activation instruction 414 and/or the removal instruction 412.

In some example embodiments, one or more steps 302, 304, and/or 306 of flowchart 300 may not be performed. Moreover, steps in addition to or in lieu of steps 302, 304, and/or 306 may be performed.

It will be recognized that focus-enabled web page module 400 may not include one or more of detection logic 402, presentation logic 404, and/or removal logic 406. Furthermore, focus-enabled web page module 400 may include logic in addition to or in lieu of detection logic 402, presentation logic 404, and/or removal logic 406.

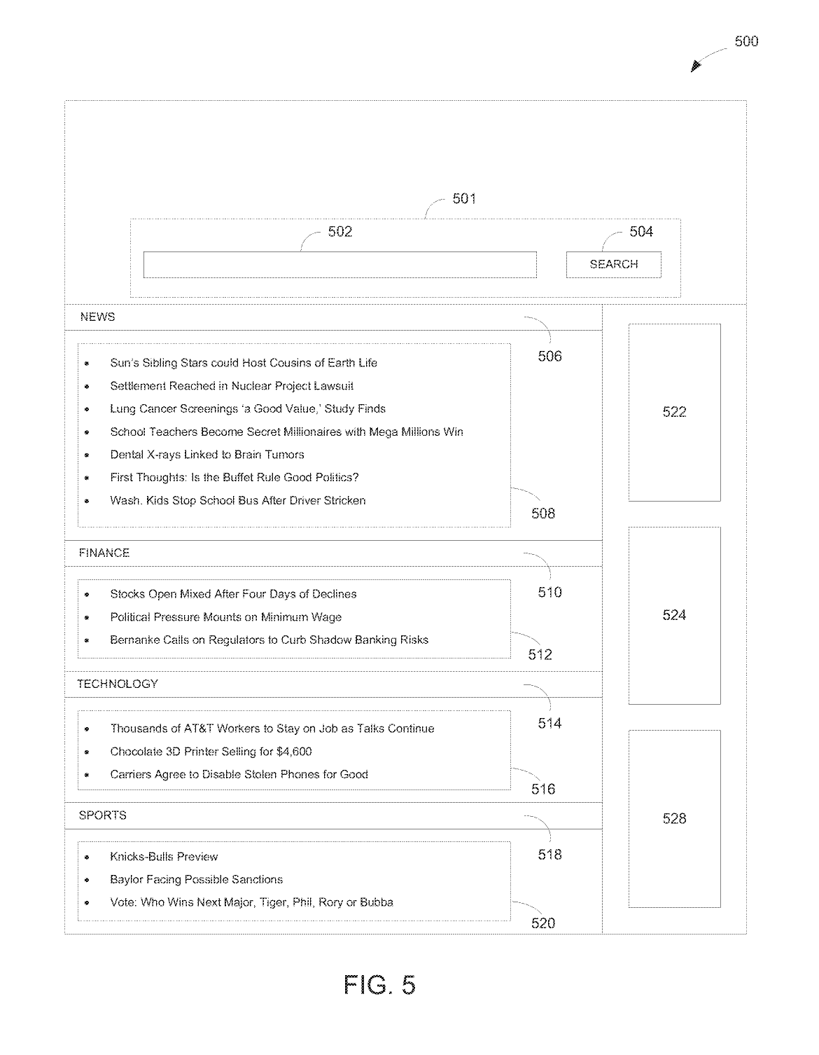

FIG. 5 shows a dynamic web page 500 in which a search module 501 and additional module(s) are presented in accordance with an embodiment described herein. Search module 501 includes a search interface element 502, depicted as a text box for illustrative purposes, for performance of a web search. Search module 501 further includes a search button 504 that causes a search query that is entered into search interface element 502 to be submitted to a search engine in response to the search button 504 being activated (e.g., selected by the user). It is noted, however, that one or more search queries may be submitted to a search engine as a user types the text that forms the one or more search queries into search interface element 502. Thus, the activation of search button 504 need not necessarily be required for submission of search queries. Dynamic web page 500 also includes a plurality of additional modules 506, 510, 514, and 518 that include respective instances 508, 512, 516, and 520 of dynamic media content. Dynamic web page 500 further includes a plurality of advertisements 522, 524 and 528 for illustrative purposes.

As shown in FIG. 5, the instances 508, 512, 516, and 520 of dynamic media content correspond to respective categories of subject matter. For example, instance 508 includes captions that correspond to a “News” category; instance 512 includes captions that correspond to a “Finance” category; instance 516 includes captions that correspond to a “Technology” category; and instance 520 includes captions that correspond to a “Sports” category. Each of the captions in instances 508, 512, 516, and 520 is a link to a respective file of the dynamic media content.

While not shown, it will be appreciated that dynamic web page 500 may display other types of content in addition to or in lieu of textual content, such as pictures, videos, etc. In addition, it is noted that the locations and/or sizes of the various modules, components, and/or advertisements shown in FIG. 5 can vary. Thus, the example provided above with reference to FIG. 5 is provided for illustration purposes and is not intended to be limiting.

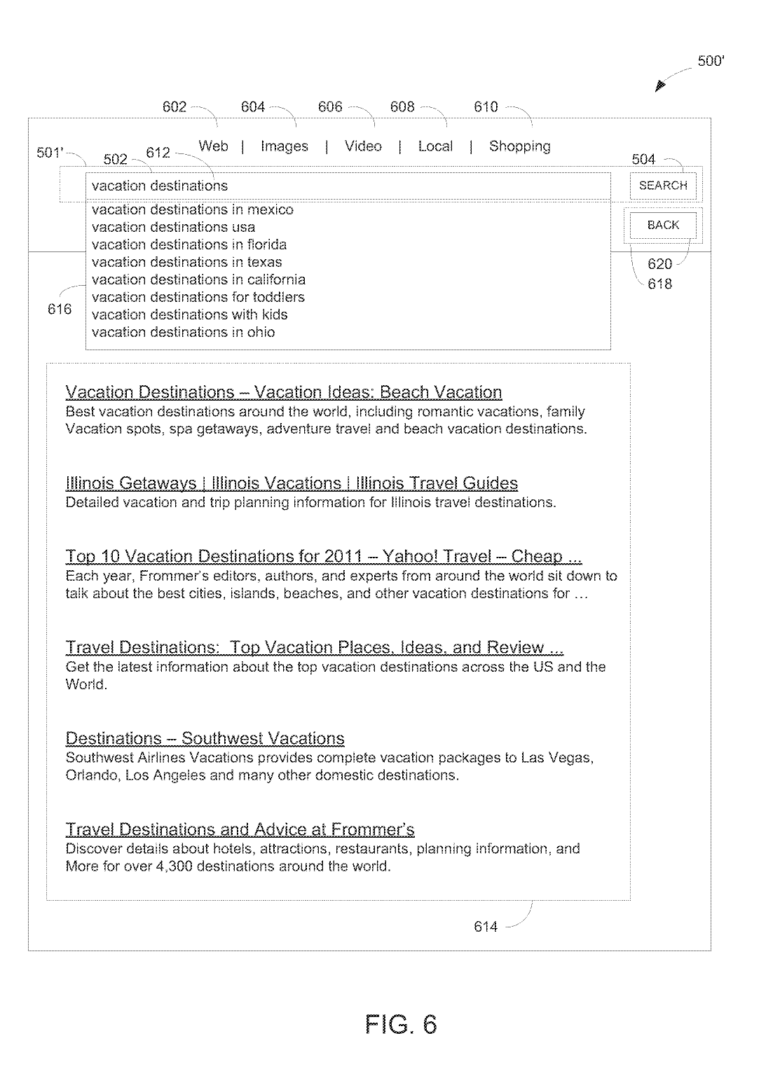

FIG. 6 shows a presentation of a dynamic web page 500′ in which focus is provided to a search module 501′ in accordance with an embodiment described herein. Focus has been provided to the search module 501′ in response to the user entering text that forms a search query 612 that includes the terms “vacation” and “destinations.” As shown in FIG. 6, additional modules 506, 510, 514, and 518 (including their respective instances 508, 512, 516, and 520 of dynamic media content) and advertisements 522, 524, 528 have been removed from the presentation of dynamic web page 500′ in response to the user entering search query 612 into search interface element 502.

In addition, the respective locations of search interface element 502 and search button 504 have been changed in response to the user entering search query 612 into search interface element 502. For instance, the respective locations of search interface element 502 and search button 504 have been changed so that search interface element 502 and search button 504 are closer to the top of dynamic web page 500′. Furthermore, the width of search interface element 502 has been increased in response to the user entering search query 612 into search interface element 502.

Dynamic web page 500′ also shows other modules that have been added in response to the user entering search query 612 into search interface element 502. For example, filter modules 602, 604, 606, 608, and 610, result module 614, suggestion module 616, and return module 618 have been added to the presentation of dynamic web page 500′.

Filter modules 602, 604, 606, 608, and 610 are configured to filter search results based on respective categories of subject matter. For example, filter module 602 filters the search results based on content found on the Internet pertaining to search query 612. Filter module 604 filters the search results such that only image files pertaining to search query 612 are provided in result module 614. Filter module 606 filters the search results such that only video files pertaining to search query 612 are provided in result module 614. Filter module 608 filters the search results such that only content pertaining to a locality of the user (e.g., local news articles, local restaurants and/or stores, etc.) and further pertaining to search query 612 are provided in result module 614. Filter module 610 filters the search results such that only results that include offers for the sale of goods and/or services on the Internet and that pertain to search query 612 are provided in result module 614.

Result module 614 includes search result(s) that are based on search query 612. Accordingly, because search query 612 includes the terms “vacation” and “destinations,” result module 614 includes search results related to those terms.

Suggestion module 616 includes suggestions of search queries that may be used by the user. Suggestion module 616 determines the suggested search queries based on search query 612. For instance, suggestion module 616 may generate the suggested search queries based on an intent of the user that is derived from search query 612. Accordingly, because search query 612 includes the terms “vacation” and “destinations,” suggestion module 616 includes suggested search queries related to those terms.

Return module 618 is configured to include a return interface element 620, depicted as a button for illustrative purposes, for returning the presentation of dynamic web page 500′ to an original state (e.g., the presentation of dynamic web page 500 shown in FIG. 5) when return interface element 620 is activated.

While not shown, it will be appreciated that dynamic web page 500′ may display other types of content in addition to or in lieu of textual content, such as pictures, videos, advertisements, etc. In addition, it is noted that the locations and/or sizes of the various modules and/or components shown in FIG. 6 can vary. Thus, the example described above with reference to FIG. 6 is provided for illustrative purposes and is not intended to be limiting.

### III. Other Example Embodiments

Focus-enabled web page module 114, search engine 118, focus-enabled web page module 400, detection logic 402, presentation logic 404, and/or removal logic 406 may be implemented in hardware, or any combination of hardware with software and/or firmware. For example, focus-enabled web page module 114, search engine 118, focus-enabled web page module 400, detection logic 402, presentation logic 404, and/or removal logic 406 may be implemented as computer program code configured to be executed in one or more processors. In another example, focus-enabled web page module 114, search engine 118, focus-enabled web page module 400, detection logic 402, presentation logic 404, and/or removal logic 406 may be implemented as hardware logic/electrical circuitry.

### IV. Example Computer Implementation

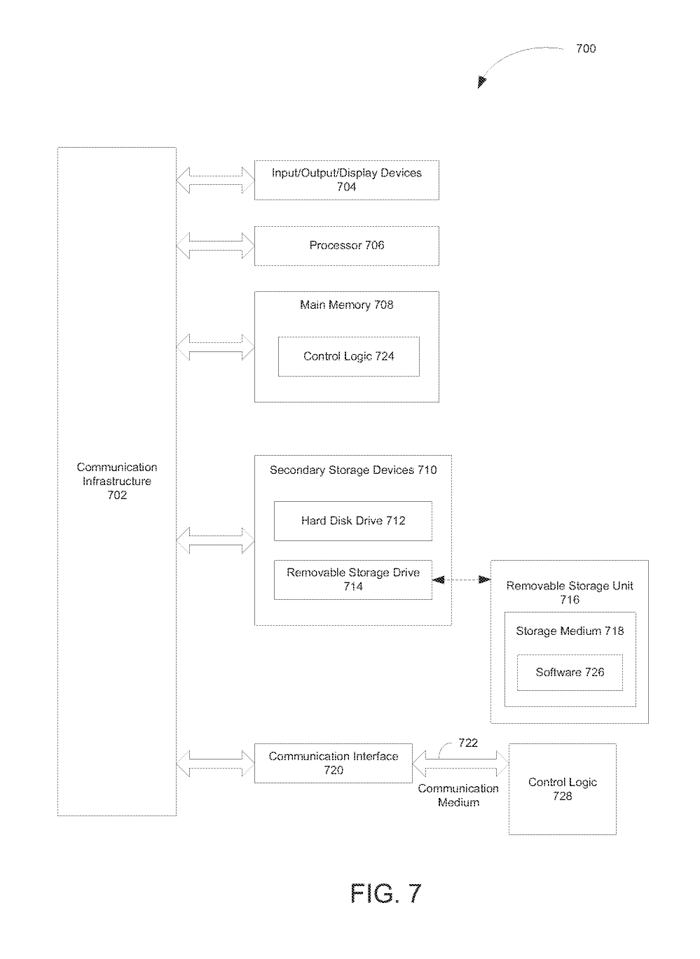

The embodiments described herein, including systems, methods/processes, and/or apparatuses, may be implemented using well known servers/computers, such as computer 700 shown in FIG. 7. For instance, elements of example system 100, including any of the user systems 102, 104, and 106, search server 116, and/or any of the publisher servers 108, 110, and 112 depicted in FIG. 1 and elements thereof, each of the steps of flowchart 200 depicted in FIG. 2, and/or each of the steps of flowchart 300 depicted in FIG. 3 can each be implemented using one or more computers 700.

Computer 700 can be any commercially available and well known computer capable of performing the functions described herein, such as computers available from International Business Machines, Apple, Sun, HP, Dell, Cray, etc. Computer 700 may be any type of computer, including a desktop computer, a server, etc.

As shown in FIG. 7, computer 700 includes one or more processors (e.g., central processing units (CPUs)), such as processor 706. Processor 706 may include focus-enabled web module 114 of FIG. 1; detection logic 402, presentation logic 404, and/or removal logic 406 of FIG. 4; or any portion or combination thereof, for example, though the scope of the embodiments is not limited in this respect. Processor 706 is connected to a communication infrastructure 702, such as a communication bus. In some embodiments, processor 706 can simultaneously operate multiple computing threads.

Computer 700 also includes a primary or main memory 708, such as a random access memory (RAM). Main memory has stored therein control logic 724 (computer software), and data.

Computer 700 also includes one or more secondary storage devices 710. Secondary storage devices 710 include, for example, a hard disk drive 712 and/or a removable storage device or drive 714, as well as other types of storage devices, such as memory cards and memory sticks. For instance, computer 700 may include an industry standard interface, such as a universal serial bus (USB) interface for interfacing with devices such as a memory stick. Removable storage drive 714 represents a floppy disk drive, a magnetic tape drive, a compact disk drive, an optical storage device, tape backup, etc.

Removable storage drive 714 interacts with a removable storage unit 716. Removable storage unit 716 includes a computer useable or readable storage medium 718 having stored therein computer software 726 (control logic) and/or data. Removable storage unit 716 represents a floppy disk, magnetic tape, compact disc (CD), digital versatile disc (DVD), Blu-ray disc, optical storage disk, memory stick, memory card, or any other computer data storage device. Removable storage drive 714 reads from and/or writes to removable storage unit 716 in a well-known manner.

Computer 700 also includes input/output/display devices 704, such as monitors, keyboards, pointing devices, microphones, motion capture devices, etc.

Computer 700 further includes a communication or network interface 720. Communication interface 720 enables computer 700 to communicate with remote devices. For example, communication interface 720 allows computer 700 to communicate over communication networks or mediums 722 (representing a form of a computer useable or readable medium), such as local area networks (LANs), wide area networks (WANs), the Internet, etc. Network interface 720 may interface with remote sites or networks via wired or wireless connections. Examples of communication interface 722 include but are not limited to a modem, a network interface card (e.g., an Ethernet card), a communication port, a Personal Computer Memory Card International Association (PCMCIA) card, etc.

Control logic 728 may be transmitted to and from computer 700 via the communication medium 722.

Any apparatus or manufacture comprising a computer useable or readable medium having control logic (software) stored therein is referred to herein as a computer program product or program storage device. This includes, but is not limited to, computer 700, main memory 708, secondary storage devices 710, and removable storage unit 716. Such computer program products, having control logic stored therein that, when executed by one or more data processing devices, cause such data processing devices to operate as described herein, represent embodiments of the invention.

For example, each of the elements of focus-enabled web page module 114 and/or search engine 118 depicted in FIG. 1; detection logic 402, presentation logic 404, and/or removal logic 406, each depicted in FIG. 4; each of the steps of flowchart 200 depicted in FIG. 2; and/or each of the steps of flowchart 300 depicted in FIG. 3 can be implemented as control logic that may be stored on a computer useable medium or computer readable medium, which can be executed by one or more processors to operate as described herein.

Computer readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

### V. CONCLUSION

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, computer readable media, media, is a machine or manufacture defined by 35 U.S.C. §101.

What is claimed is:

1. A method of providing focus to a search module, comprising:
providing a dynamic web page that includes a plurality of modules for presentation to a user, the plurality of modules including the search module configured to include an interface element for performance of a web search and further including one or more additional modules via which one or more respective instances of dynamic media content are to be presented, each instance of the dynamic media content including at least one of textual content, graphical content, video content, or audio content;
detecting an input from the user that initiates use of the search module; and
removing the one or more additional modules from the presentation of the dynamic web page such that the presentation of the dynamic web page includes the search module without the one or more additional modules in response to detecting the input from the user.

2. The method of claim 1, further comprising:
changing a location of one or more components of the search module in the presentation of the dynamic web page in response to detecting the input from the user, the one or more components of the search module including at least the interface element.

3. The method of claim 1, further comprising:
changing one or more physical dimensions of one or more components of the search module in the presentation of the dynamic web page in response to detecting the input from the user, the one or more components of the search module including at least the interface element.

4. The method of claim 1, wherein detecting the input comprises:
detecting a mouse click received by the interface element from the user.

5. The method of claim 1, wherein detecting the input comprises:
detecting text entered into the interface element by the user, the text forming a search query.

6. The method of claim 5, further comprising:
removing M advertisements from the presentation of the dynamic web page such that the presentation of the dynamic web page includes the search module without the M advertisements in response to detecting the text entered into the interface element by the user, M being an integer; and
adding N advertisements to the presentation of the dynamic web page in response to detecting the text entered into the interface element by the user, N being an integer that is greater than M.

7. The method of claim 5, further comprising:
adding one or more result modules to the presentation of the dynamic web page in response to detecting the text entered into the interface element by the user, each of the one or more result modules including one or more search results based on the search query.

8. The method of claim 5, further comprising:
adding one or more suggestion modules to the presentation of the dynamic web page in response to detecting the text entered into the interface element by the user, each of the one or more suggestion modules including one or more suggested search queries based on the search query.

9. The method of claim 5, further comprising:
adding one or more filter modules to the presentation of the dynamic web page in response to detecting the text entered into the interface element by the user, the one or more filter modules being configured to filter search results based on one or more respective categories of subject matter when activated, the search results being based on the search query.

10. The method of claim 1, further comprising:
adding a second additional module to the presentation of the dynamic web page in response to detecting the input from the user, the second additional module being configured to include a second interface element for returning the presentation of the dynamic web page to an original state, the presentation of the dynamic web page in the original state comprising the search module and the one or more additional modules.

11. The method of claim 1, wherein the one or more additional modules include a plurality of the additional modules that correspond to a plurality of respective categories of subject matter, each additional module in a subset of the plurality of additional modules including one or more captions corresponding to one or more respective links that are linked to one or more respective files of the dynamic media content that are associated with the category that corresponds to the respective additional module.

12. A system, comprising:
presentation logic configured to provide a dynamic web page that includes a plurality of modules for presentation to a user, the plurality of modules including a search module configured to include an interface element for performance of a web search and further including one or more additional modules via which one or more respective instances of dynamic media content are to be presented, each instance of the dynamic media content including at least one of textual content, graphical content, video content, or audio content;
detection logic configured to detect an input from the user that initiates use of the search module; and
removal logic configured to remove the one or more additional modules from the presentation of the dynamic web page such that the presentation of the dynamic web page includes the search module without the one or more additional modules in response to detection of the input from the user.

13. The system of claim 12, wherein the presentation logic is further configured to change one or more physical dimensions of one or more components of the search module in the presentation of the dynamic web page in response to detection of the input from the user, the one or more components of the search module including at least the interface element.

14. The system of claim 12, wherein the input from the user includes a voice command from the user, the voice command being directed to initiate the use of the interface element.

15. The system of claim 12, wherein the input from the user includes a hand gesture made by the user, the hand gesture being directed to initiate the use of the interface element.

16. The system of claim 12, wherein the input from the user includes a cursor being hovered over the interface element by the user for at least a predetermined time interval.

17. The system of claim 12, wherein the input from the user includes text entered into the interface element by the user, the text forming a search query.

18. The system of claim 17, wherein the presentation logic is further configured to add one or more result modules to the presentation of the dynamic web page in response to detection of the text entered into the interface element by the user, each of the one or more result modules including one or more search results based on the search query.

19. The system of claim 17, wherein the presentation logic is further configured to add one or more suggestion modules to the presentation of the dynamic web page in response to detection of the text entered into the interface element by the user, each of the one or more suggestion modules including one or more suggested search queries based on the search query.

20. A computer program product comprising a computer-readable storage medium having computer program logic recorded thereon for enabling a processor-based system to provide focus to a search module, the computer program product comprising:
a first program logic module for enabling the processor-based system to provide a dynamic web page that includes a plurality of modules for presentation to a user, the plurality of modules including a search module configured to include an interface element for performance of a web search and further including one or more additional modules via which one or more respective instances of dynamic media content are to be presented, each instance of the dynamic media content including at least one of textual content, graphical content, video content, or audio content;
a second program logic module for enabling the processor-based system to activate the search module based on receipt of an activation instruction from the user, the activation instruction indicating that the search module is to be activated; and
a third program logic module for enabling the processor-based system to remove the one or more additional modules from the presentation of the dynamic web page such that the presentation of the dynamic web page includes the search module without the one or more additional modules in response to receipt of the activation instruction from the user.
